(19) United States
(12) Patent Application Publication
(10) Pub. No.: US 2020/0223721 A1
(43) Pub. Date: Jul. 16, 2020

(54) METHOD FOR MAINTAINING POSITIVELY CHARGED COLLOIDAL PARTICLES AFTER DIFFUSIOPHORETIC WATER FILTERING

(71) Applicant: Split Rock Filter Systems LLC, New Paltz, NY (US)

(72) Inventor: William C. Gehris, New Paltz, NY (US)

(21) Appl. No.: 16/744,409

(22) Filed: Jan. 16, 2020

Related U.S. Application Data
(60) Provisional application No. 62/793,093, filed on Jan. 16, 2019.

(51) Int. Cl. C02F 1/68; C02F 1/00; C02F 1/52

(52) U.S. Cl. CPC C02F 1/68; C02F 1/001; C02F 2303/04; C02F 2001/007; C02F 1/52

(57) ABSTRACT

A method for diffusiophoretically filtering a colloid containing water and both positively and negatively charged colloidal particles including moving the colloid through a diffusiophoretic water filter; splitting the colloid into a first stream and a second stream, the first stream having a higher concentration of the negatively charged colloidal particles and lower concentration of the negatively charged colloidal particles than the second stream; and providing the second stream as potable water without further filtering of the positively charged colloidal particles.

This claims the benefit of provisional patent application U.S. 62/793,093, filed on Jan. 16, 2019, which is hereby incorporated by reference herein.

U.S. patent application Ser. No. 16/262,633, filed on Jan. 30, 2019 and PCT Publication No. WO 2019/099586, filed as PCT/US18/61146 on Nov. 14, 2018 are also hereby incorporated by reference herein.

PCT Patent Application Publication No. WO 2018/048735A1 and U.S. Pat. No. 10,155,182 B1 both of which are hereby incorporated by reference herein disclose diffusiophoretic water filters that can remove both negatively charged and positively charged colloidal particles from water via the process of diffusiophoresis. This process acts on colloidal particles having a surface charge, or positive or negative zeta potential in the colloid.

### SUMMARY OF THE INVENTION

Many colloidal particles in drinking water are negatively charged, including most bacteria and viruses. There are also positively charged colloidal particles, often from metallic oxides or clays.

The present invention provides a method for diffusiophoretically filtering a colloid containing water and both positively and negatively charged colloidal particles comprising:

moving the colloid through a diffusiophoretic water filter;

splitting the colloid into a first stream and a second stream, the first stream having a higher concentration of the negatively charged colloidal particles and lower concentration of the negatively charged colloidal particles than the second stream;

providing the second stream as potable water without further filtering of the positively charged colloidal particles.

The present invention eliminates the need for a three stream output structure or a second filtering for positively charged particles. Surprisingly, many positively charged particles may have health benefits and the maintenance of those particles in the filtrate second stream can actually be advantageous. It is surmised that certain metal oxides and clay particles that are not unhealthy for human consumption may remain in the second stream.

The first stream can be further treated, for example with UV light to kill the viruses and bacteria, or discarded and treated as waste.

### BRIEF DESCRIPTION OF THE DRAWINGS

FIG. 1 shows a method according to the present invention.

### DETAILED DESCRIPTION

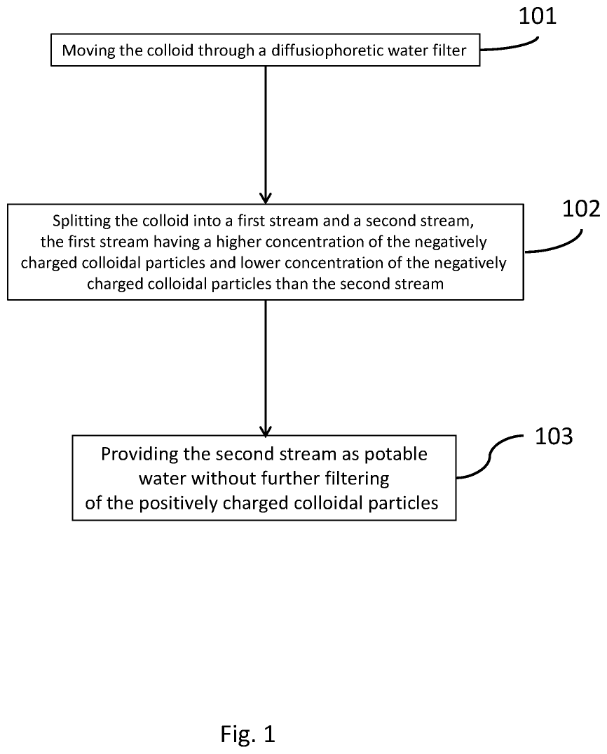

FIG. 1 discloses a method for diffusiophoretically filtering a colloid containing water and both positively and negatively charged colloidal particles. In step 101, a colloid such as water from a river that has passed through a flocculation and sediment step, and then through a sand filter. The prefiltered colloid then passes through a diffusiophoretic water filter. The colloid still contains live viruses, parasites, bacteria and other charged micro or nanoparticles that have passed through the prefiltering.

In step 102, the colloid is split into a first stream and a second stream, the first stream having a higher concentration of the negatively charged colloidal particles and lower concentration of the negatively charged colloidal particles than the second stream. Thus the first stream can contain most of the viruses, parasites, bacteria and other charged micro or nanoparticles, the majority of which are negatively charged.

The second stream may still contain a very small amount of negatively charged particles, to a level that is not unhealthy, and some amount of positively charged particles.

In step 103, the second stream, without further filtering of the positively charged colloidal particles, is provided as a filtrate to be used for example as drinking water or for industrial or agricultural purposes.

The present invention thus eliminates the need for a three stream output structure or a second filtering for positively charged particles. Surprisingly, many of the positively charged particles may have health benefits and the maintenance of those particles in the filtrate second stream can actually be advantageous. It is surmised that certain metal oxides and clay particles that are not unhealthy for human consumption, and certainly fine for agricultural use, may remain in the second stream. In particular, the present invention may have special use for agricultural purposes to eliminate or reduce the threat of bacteria such as E. coli, which is negatively charged. Potable water is thus defined as water for human, animal, industrial or agricultural consumption.

The first stream however can be further treated, for example with UV light to kill the viruses and bacteria, or discarded and treated as waste.

What is claimed is:

1. A method for diffusiophoretically filtering a colloid containing water and both positively and negatively charged colloidal particles comprising:
moving the colloid through a diffusiophoretic water filter;
splitting the colloid into a first stream and a second stream, the first stream having a higher concentration of the negatively charged colloidal particles and lower concentration of the negatively charged colloidal particles than the second stream; and
providing the second stream as potable water without further filtering of the positively charged colloidal particles.
